(19) United States
(12) Patent Application Publication
(10) Pub. No.: US 2013/0179368 A1
(43) Pub. Date: Jul. 11, 2013

(54) SPREAD LOCK ANNUITY SYSTEM AND METHOD

(71) Applicant: Bill Templeton, Atlanta, GA (US)

(72) Inventor: Bill Templeton, Atlanta, GA (US)

(21) Appl. No.: 13/738,873

(22) Filed: Jan. 10, 2013

Related U.S. Application Data
(60) Provisional application No. 61/584,902, filed on Jan. 10, 2012.

(51) Int. Cl. G06Q 40/06

(52) U.S. Cl. 705/36 R

(57) ABSTRACT

Systems and methods for financial assets are disclosed. The spread lock annuity system is directed to optimally exploit current market structure characteristics by avoiding today's low rates as much as possible, capturing today's great spreads as much as possible, for future premium payment when future interest rates and especially future funding levels are more attractive than today's and avoids the possibly adverse accounting impact of a traditional annuity purchase by temporarily using the “buy in” annuity structure until the Plan sponsor wishes to fully purchase the annuity or otherwise convert from buy-in to buy-out.

### CROSS REFERENCE TO RELATED APPLICATIONS

The present application claims the benefit of U.S. application No. 61/584,902, filed Jan. 10, 2012 and titled STABLE VALUE BIFURCATION & SPREAD LOCK ANNUITY SYSTEMS & METHODS, which is herein incorporated by reference in its entirety.

### FIELD OF THE INVENTION

The technology described herein relates generally to financial systems. In particular, the technology described herein relates to annuities.

### BACKGROUND OF THE INVENTION

The term annuity refers to any terminating stream of fixed payments over a specified period of time. This usage is most commonly seen in discussions of finance, usually in connection with the valuation of the stream of payments, taking into account time value of money concepts such as interest rate and future value.

Examples of annuities are regular deposits to a savings account, monthly home mortgage payments and monthly insurance payments. Annuities are classified by the frequency of payment dates. The payments (deposits) may be made weekly, monthly, quarterly, yearly, or at any other interval of time.

Because annuities comprise a form of life insurance whereby the payments are guaranteed by the carrier for the life of the annuitant, the group annuity policies (which may cover dozens, hundreds or even thousands of annuitants) are not considered investments and are not subject to SEC regulation. Rather, they are considered to be insurance products and as such, are regulated by the state insurance commissioners.

Group Annuity Guarantees History:
a. Group Annuity guarantees for future deposits have been around for decades—indeed, for effectively the entire history of Group Annuity contracts. Minimum interest guarantees on all deposits for a specified number of years were characteristic of Deposit Administration contracts, IPGs and their variants for Defined Contribution plans like Aetna's Multivestor or Equitable's recurring deposit GIC, to name a mere handful among many, where prevalent throughout most of the history of Group Annuity contracts generally.
b. The guarantees have always been in terms of specific interest rates or specific annuity purchase rates. That is, minimum interest rates would be guaranteed for a specified period of time, on all deposits received within a separate specified period of time, which might be the same, or not, e.g. X % for 10 years on all deposits received in the first five years. Moreover, the robustness of the guarantees applicable to future deposits has always been proportionate to the ratio of initial deposit to future deposits. That is, if the initial deposit is many times the amount of subsequent deposits, then the bulk of the total deposits under the guaranteed rate is received under today's conditions, not future conditions as with the subsequent deposits. Because all deposits are under the same guarantee structure, if today's deposits represent 75% of total deposits, then that guarantee structure has less risk than when only 25% of all expected deposits being guaranteed are being received today.

Currently the Annuity Market Key Aspects are:
a. low rates,
b. expensive annuities as a result, relative to historical cost,
c. underfunded plans in general,
d. buyer's market, great spreads on winning quotes, but at expensive low rates,
e. many, many plan sponsors looking to annuitize when it's “cost neutral” due to improved conditions,
f. relatively few annuity purchases as a result, relative to historical activity, though this may be changing due to market development of “buy-in” annuities given the noteworthy 2012 annuity purchases of GM and Verizon from Prudential.

Thus, looking forward:
a. as interest rates increase these plans will become better funded;
b. more annuities will be bought when rates are higher and the cost of the annuities less, particularly if with no adverse accounting aspects as funding improves. Indeed, if demand for buy-in annuities continues, the increase in purchase volume and consequence decrease in spreads may not even require a rate increase to become manifest;
c. thus, today's “buyer's market” annuity spreads will gradually worsen to “seller's market” spreads as the annuity supply/demand relationship changes. Indeed, this change may already be starting, due to the increase in client demand prompted by the recent Verizon and GM mega-purchases;
d. as the significant number of frozen plans “waiting in the weeds” begin to act as interest rates (and funding levels) improve, today's annuity market great spreads (but low rates) will switch to higher rates but poor spreads;
e. even if rates do not increase in the future—a problematic proposition, given today's historically low level of rates coupled with today's U.S. deficit, debt, credit downgrade and the Fed's recent QE activities—many (if not most) corporate qualified DB Plans are “waiting in the weeds” to terminate and transfer the Plan's liabilities elsewhere when funding improves enough to do so, regardless of whether that funding improvement derives from future rate increases, equity market performance or further contributions;
f. In short, there's reason to believe that the current “buyer's market” conditions will revert to “seller's market” as funding improves, whereby today's excellent spreads will decline as the annuity market's supply/demand characteristics change. Indeed, this may already be occurring due to recent marketplace activity.

The need exists for a solution that addresses this situation.

The foregoing information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to financial systems and methods.

The essence of the Spread Lock annuity is that it only involves purchasing a portion of participants' benefits. Instead of buying 100% of the retirees' benefits, for example, the Spread Lock annuity only purchases a portion such as 10%, 25%, 50%, etc.—whatever is mutually agreed by the carrier and Plan sponsor.

What's unique about the Spread Lock annuity is that it also involves, as part of the purchase of a portion of benefit, an option on the part of the Plan sponsor to purchase the rest of the participants' benefits on a pre-agreed basis linked to spreads of Aa bonds, not future minimum rate guarantees, as has historically been the case.

As such, the Spread Lock Annuity does what no other currently existent annuity does: it minimizes the Plan sponsor's purchase at today's low and unattractive rates while at the same time “locking in” for the Plan sponsor guaranteed access to today's great spreads, at tomorrow's higher rates. As such it combines (a) the carriers' need to generate some actual annuity purchase business today (i.e. despite today's low rates) with the Plan sponsor's desire to (b) establish a glide-path for eventual transfer of their pension plan liabilities, at least for retirees, to the “safest available” party but at a reasonable cost. The Plan Sponsor concern is that as rates rise and annuity demand picks up, spreads will greatly worsen and capacity will diminish as the annuity market shifts from today's buyer's market to tomorrow's seller's market.

The carrier does potentially sacrifice some potential future opportunity cost, but many will be comfortable exchanging a future potential opportunity cost for a new annuity business today, when they are desperate for it, and which will not represent a material future risk since it's just the spread, not the future rate, that's locked in.

Spread Lock Annuity—Invention Rationale and Structural Outline: the “Spread Lock Annuity” (SLA) is specifically engineered to optimally exploit these market structure characteristics, by:
g. avoiding today's low rates as much as possible,
h. capturing today's great spreads as much as possible, for future premium payment when future interest rates and especially future funding levels are more attractive than today's, and
i. avoids the possibly adverse accounting impact of a traditional annuity purchase by temporarily using the “buy in” annuity structure until the Plan sponsor wishes to fully purchase the annuity or otherwise convert from “buy-in” to “buy-out.”

What the Spread-Lock annuity does, for the first time in the history of Group Annuity product structures, is to guarantee not an interest rate or purchase rate but rather, a spread on future purchases (i.e. deposits by another name) relative to an initial purchase that is part of the contract. The key historical structure of group annuity guarantees is preserved in the sense that the size of the risk charge to be assessed the guaranteed spread applicable to future purchases (i.e. future deposits or premium payments) is dependent on the ratio that such future purchases bear to the initial purchase. If 50% of the total benefits to be purchased are bought initially, then there is less risk applicable to the subsequent purchases than if the initial purchase only constitutes 25% of the total to be bought.

From the client's perspective it is an attractive arrangement because there's a contractually established—but optional—pathway to full risk transfer over a specified future number of years, with (a) today's market's unattractively low interest rates applying only to the initial purchase, but with (b) today's attractive spreads applying to the subsequent years' purchases reflective of then-current interest rates, which would seem to have a good chance of being higher, because today's are so low.

From the carrier's perspective, it is an attractive way to acquire annuity business at more reasonable spreads than most conventional annuity transactions nowadays, which can actually be negative due to severe buyers' market conditions (though those conditions may be changing due to some recent major purchases despite today's low rates). Also the carrier is only guaranteeing a spread on future purchases off its own initial purchase, using its preferred—but objective—definitional criteria for “future rates,” and is not guaranteeing a spread off a different, less comfortable class of security or index.

How the Spread Lock Annuity Operates: The traditional annuity structure involves purchasing 100% of the benefit or benefits to be annuitized. If, for example, the total retiree liability of a given corporate pension plan involves 5,000 individuals, $2 million in total monthly benefits for those retirees and a present value of $300 million, then the traditional annuity structure for that liability would likewise involve the full $2 million in monthly benefits being purchased with a premium in the vicinity of $300 million based on current interest rates and annuity spreads, which may involve net annuity rates within 100 basis points below gross Aa yields of appropriate duration.

In contrast, the Spread Lock Annuity involves:
1. purchasing only a fraction of the monthly benefits
2. for a corresponding fraction of the $300 million cost but with
3. an added feature consisting of spread guarantees on the remainder, provided the remainder is purchased within specified parameters.

Thus, instead of buying the full $2 million in monthly benefits, only $500,000 might be bought, e.g., 25% of each retiree's benefit, with the client having the option to purchase the remaining 75% at pre-specified spreads (but not pre-specified rates). For example, if the net/net rate underlying the 25% that is bought today is 50 points off the appropriate external index (such as Moody's Aa bond yield, the Citicorp bond yield or another mutually agreed basis), then the balance could be bought at a specified spread that's negotiated as part of the 25% purchase. It might be the same 50 pts., 75 pts. or 100 pts., whichever is negotiated at the time of the initial 25% purchase.

The remaining 75% to be purchased is at the Plan sponsor's discretion, but the guaranteed spreads would require parameters to preserve the spread guarantee, such as a minimum additional purchase of at least 5% per year for each of the next five years, or whatever other minimum amount and future time period is negotiated between the parties. The additional purchases at pre-specified spreads could be in the form of a pure option (where the only cost to the Plan sponsor for not purchasing the minimum added liability percentages per the agreed parameters is the loss of the spread guarantee on the remainder to be purchased) or a futures contract (where there's also a small reduction in the amount already purchased if the future purchases do not occur, presuming the initial 25% is purchased on a buy-in basis).

The initial purchase may be 25%, 50%, 75% or some other percentage agreed between the parties. Likewise the future purchase increment minimums to preserve the Spread Lock may be other than 5% per year, and the period over which the remaining benefits could be purchased under the Spread lock could be other than five years. These are best negotiated between the insurance company issuing the Spread Lock Annuity and the Plan Sponsor. Regardless of those variable details, the Spread Lock Annuity is completely unique in today's group annuity market in that it takes today's unattractive annuity market conditions and flips them around entirely to create a compelling argument to buy today.

This is because the Spread Lock Annuity methodology:
a. minimizes exposure to today's unattractive low rates,
b. maximizes exposure to today's excellent spreads, and
c. creates a logical “glide-path” for all Plan sponsors, both under-funded and fully-funded, to transfer their retiree liabilities as future interest rates and funding improves.

All annuities, including the Spread Lock annuity, require extensive computer calculations and process to price and administer, since the life expectancies of each annuitant, and often the annuitants' beneficiaries too, need to be reflected in the calculations.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 illustrates a future annuity market projection without the spread lock system; and

FIG. 2 illustrates a future annuity market projection with the spread lock system, according to an embodiment of the technology described herein.

### DETAILED DESCRIPTION OF THE INVENTION

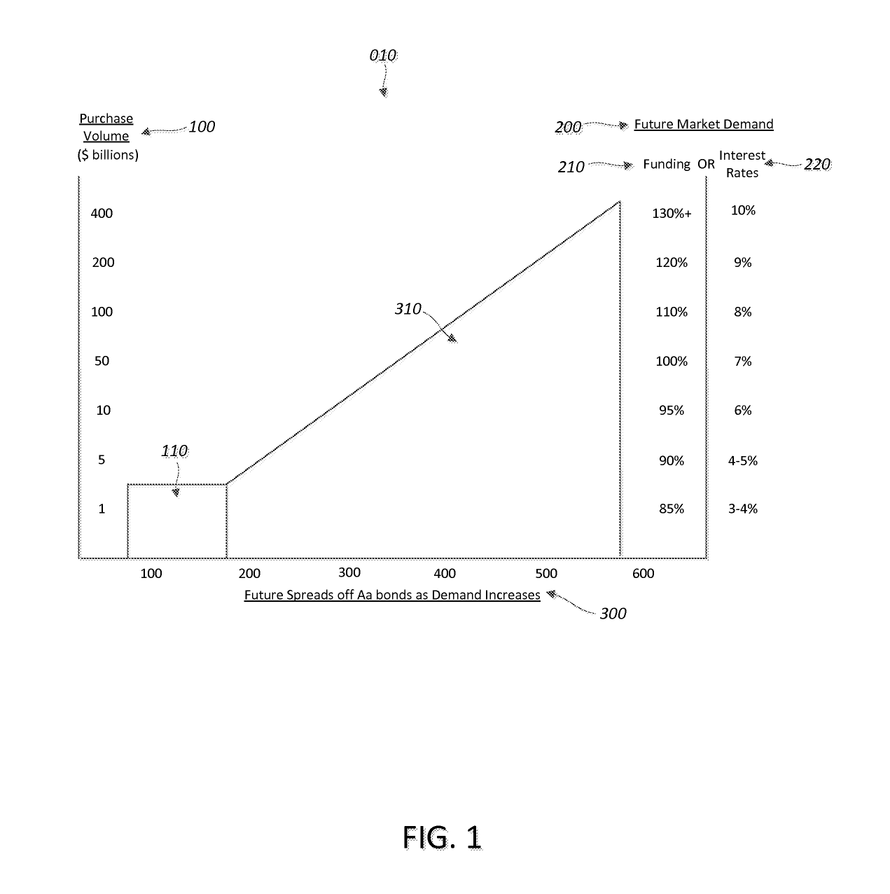

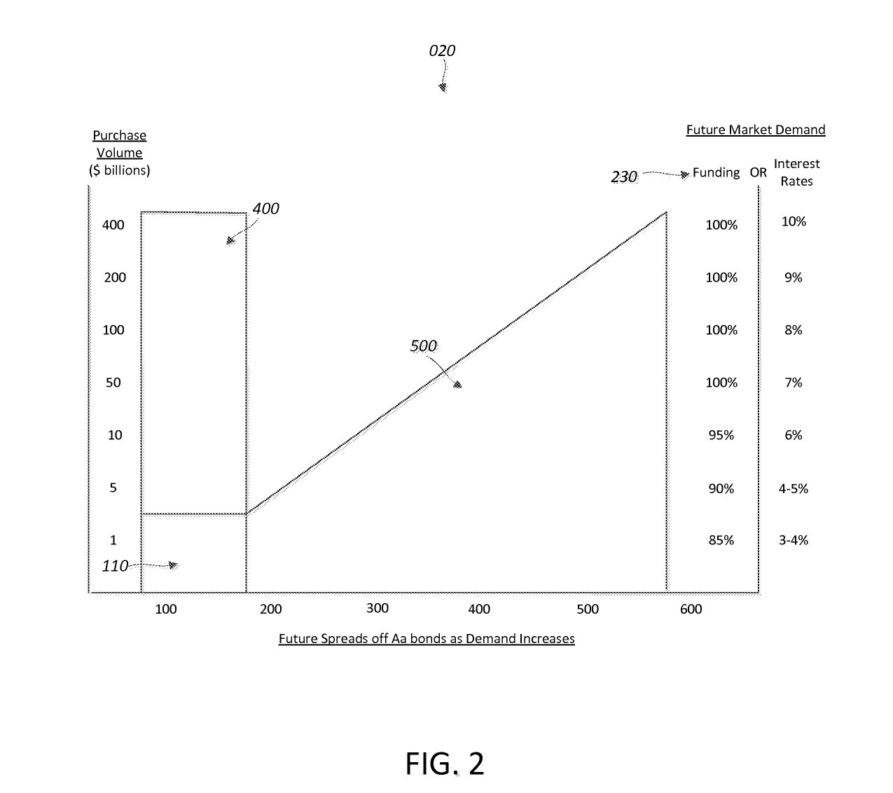

In describing the preferred and other embodiments of the technology described herein, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Mechanical Details for Spread-Lock Annuity Operation are as follows.

Annuity Basis—Determination and Assurance of Mutual Understanding: Because the essence of the Spread-Lock Annuity concept is an abstract “pricing spread” between (a) today's annuity price and rates and (b), future annuity prices and rates, both seminal parties to the group annuity transaction, i.e., the insurance company issuing the contract and the retirement plan sponsor, usually a corporate entity like the insurance company, need to be in agreement as to exactly what “spread” is being “locked in,” and how that spread, when applied in the subsequent purchase years at then-prevailing interest rate levels, will produce a predictable and “surprise-free” annuity cost with respect to those subsequent years' purchases.

That is, the insurance company and plan sponsor need to be able to mutually agree at point of initial purchase, how the subsequent years' purchase prices will be for any given future rate environment.

Item One, the Plan Sponsor identifies what percentage of total retiree liability they wish to potentially transfer to the carrier over the purchase period. Any percentage will do, but the total to potentially be transferred must be established up-front, be it 100%, 50%, 25%, or whatever, in order to limit the potential exposure of the insurance company, consistent with the structure of Group Annuity contracts for decades. (For example, Deposit Administration and IPG contracts have historically contained purchase rate guarantees for future purchases extending for decades, but limited only to monies received in the first five years. The Spread Lock Annuity is similar, but instead of having fixed prices and rates guaranteed for future purchase, the Spread-Lock annuity fixes the pricing basis but the rate floats until such future purchase is made).

The basis for determining what portion of the total retiree liability to be potentially covered under the contract must be free of anti-selection, i.e., it can't be only the healthy ones likely to outlive their expected mortality. Rather, the basis for determining what portion of the retiree liability to be covered must be neutral, such as an equal percentage of all retirees, or all retirees in a given business unit, possibly every other or every third retiree or other basis mutually agreeable to the insurance company and Plan sponsor.

There are fiduciary aspects to this decision, since even for buy-in annuities ultimately the annuity liability will likely be transferred to the carrier pursuant to eventual plan termination or settlement. Thus, it is recommended, but not required, under the Spread-Lock Annuity methodology, that each retiree as of the contract's effective date receives a uniform percentage of coverage under the annuity, in order to have uniform credit risk exposure among all retirees, i.e., a uniform purchase percentage means no retiree asks, pursuant to the worst-case future possible eventuality: “how come I got carrier A who failed whereas my former co-worker got carrier B which didn't fail).

Item Two(a), the insurance company provides a quote on that portion of the liability to be potentially covered under the contract for the initial purchase, plus how that quote would change for different percentages of coverage and identifies how that quote would be under different levels of interest rate, all other things being equal.

Carrier quote: $X. The carrier identifies the interest rate and mortality basis underlying the quote, which the plan actuary verifies. We'll call this Rate X %.

Since there are many, many examples in the history of group annuity negotiations of misunderstandings between carriers and plan sponsors as to annuity rates even with seemingly similar assumptions with which the inventor has personal knowledge, the application of Rate X % at various future levels (i.e. X % plus 100 bp, plus 300 bp, etc.), the future price application for increases in rates is established under the Spread-Lock step two: how quote $X would change at different rate levels:

| Future rates (Rate X % plus): | 100 pts. | 200 pts. | 300 pts. | 400 pts. | etc |
|---|---|---|---|---|---|
| Future cost (as a % of $X) | aa.a % | bb.b % | cc.c % | dd.d % | etc |
| based on Today's quote data | | | | | |

Thus, Item Two identifies both (a) the key variable (the net interest rate), Rate X %, underlying the initial quote, plus (b) the impact of specific changes in Rate X % pursuant to both future rate increases and future purchases. This is critical because it gives specific substance to what's critical to the Spread-Lock Annuity concept, which is to enable the future purchases of discrete future liabilities at a pre-established basis except for the interest rate, which floats with prevailing rates until it is “locked-in” with respect to each such subsequent purchase.

Item Two (b), the carrier identifies how the above values would change, for different percentages of initial purchase. Because the Spread-Lock annuity concept involves not purchasing the entire benefit, but instead establishing the structure to allow for future purchase (such as when interest rates are higher,) the purchase price information in Item Two (a) above needs to be refined to show purchase values for less than 100% of the benefits, since, consistent with the entire intent of the Spread-Lock concept, the entire idea is to buy only a portion now and the rest later.

The simplest approach would be pure pro-rata, i.e. if the carrier's price for 100% of the benefits is $X, then for half of each benefit the cost would simply be 0.5 ×$X. But, the parties may agree if desired to a more complicated approach if desired in order to capture the exact effect of fixed expenses. The important thing is for both parties to the contract tp understand the cost implications of interest rate changes on the liability being purchased today, and on the portion not being purchased today but available for purchase later, over the term of the purchase period (most carriers will be uncomfortable with a purchase period that extends past five years).

Item Three: the impact of future mortality must also be identified, to avoid potential misunderstandings between the parties. This is accomplished by the carrier projecting the value of $X in three year's time, based on the mortality expectations underlying its quote. It uses the exact same methodology as in Item Two above, except projected three years:

Cost of today's data projected for three years based Rate X %: $Y

Future rates (Rate X % plus,) 100 pts. 200 pts. 300 pts. 400 pts. 500 pts. 600 pts. 700 pts. etc

as defined per Item Two)

Future cost (as a % of hh.h %, ii.i %, jj.j %, kk.k % ll.l %, mm.m %, nn.n %, etc.

$Y based on

Quote mortality projected

3 years

The purpose of Item three is to minimize the potential for misunderstandings between the parties from all reasonably possible causes, i.e. future net interest rates and future mortality. By delineating the price impact of both future rates and future projected mortality, the Spread-Lock Annuity contains the necessary structure to enable all parties to pre-identify, to the extent possible, the future cost of the annuities to be bought in the future, based on (a) future rates and (b) today's mortality expectations.

Item Four: the reference basis for future increases in rates must be defined for purchases under the Spread Lock. Importantly, Item two identifies the price impact of changes in future interest rates pursuant to the Spread Lock, but in addition there needs to be agreement between the parties as to how the future rate is determined, i.e. rates in general may increase, but a specific basis is needed. It could be Moody's Aa, which is conceptually logical inasmuch as the carriers in the annuity market for both buy-in and buy-out annuities are generally Aa rated. But, some carriers and Plan sponsors may want to use another basis, such as 10 year Treasury bonds, for example. The critical item is not the specific reference basis, but rather that both parties agree to a specific basis, in order to precisely define the increase or decrease in rates to be applied under the contract.

For example, consider the following hypothetical rate comparisons:

| | Today | In Future Year 3 | In Future Year 5 |
|---|---|---|---|
| Moody's Aa | 4.0% | 4.5% | 7.5% |
| 10 year Treasury | 3.0% | 4.0% | 6.0% |
| Rate X % (initial | 3.5% | | |
| purchase) | | | |

| | |
|---|---|
| Rate X % (if Moody's | |
| Aa is used to define) | |
| rate changes) in | |
| Year 3 purchase: | 4.0% |
| Year 5 purchase: | 7.0% |
| Rate X % (if 10 year | |
| Treasury is used to | |
| define rate changes) in | |
| Year 3 purchase: | 4.5% |
| Year 5 purchase: | 6.5% |

The parties can agree to whichever reference basis they are most comfortable with for purposes of defining future rate increases or decreases to Rate X %, but it will need to remain fixed for the duration of the contract, unless the parties agree otherwise. Critically, the reference basis is only to define the increase or decrease in rates, for purposes of future purchases. The reference basis defines how Rate X % is to modified for future purchase, it does not require that the future purchase actually be at that reference basis.

Importantly, in order to minimize its risk to spread changes, the carrier and/or plan sponsor may be optimally comfortable using an average of external measures for purposes of defining future interest rate increases or decreases. For example if this averaging approach were used for the Moody's Aa yield and the 10 year Treasury, then the above table would change as follows (changes in bold):

| | Today | In Future Year 3 | In Future Year 5 |
|---|---|---|---|
| Moody's Aa | 4.0% | 4.5% | 7.5% |
| 10 year Treasury | 3.0% | 4.0% | 6.0% |
| Rate X % (initial | 3.25% | | |
| purchase) | | | |

| | |
|---|---|
| Rate X % (if Moody's | |
| Aa is used to define) | |
| rate changes) in | |
| Year 3 purchase: | 4.0% |
| Year 5 purchase: | 7.0% |
| Rate X % (if 10 year | |
| Treasury is used to | |
| define rate changes) in | |
| Year 3 purchase: | 4.5% |
| Year 5 purchase: | 6.5% |
| Rate X % if average is used | |
| Year 3 purchase: | 4.25% |
| Year 5 purchase: | 6.75% |

Item Five: what population to use in subsequent purchases? There are two conceptual possibilities: (a) subsequent purchases can be made based on actual experience or (b) subsequent purchases can be based on expected experience at date of initial purchase. To illustrate the distinction with an extreme example, if the subsequent purchases were based on originally expected experience at date of initial purchase, but in fact twice as many of the retirees died as was originally expected, then the subsequent purchases would include people who no longer were living. Likewise, if none of the retirees died, then the subsequent purchases would include more people than priced for. Both examples are absurd, but conceptually need to be addressed in order to avoid such an absurd result.

That is, what's being “locked-in” is the mortality basis but not the actual experience itself. To avoid disintermediation, the subsequent purchases should be based on actual experience to date of subsequent purchase, of course solely with respect to the portions of benefit not previously purchased. The “locked-in” mortality basis would be applied to the actually remaining benefits to be subsequently purchased, in other words.

Thus, in contrast to the above example, if twice as many retirees died as expected, the subsequent purchase would be only with respect to those surviving retirees, with mortality expectations from date of subsequent purchase based on the mortality basis “locked in” at initial purchase (i.e. not modified to reflect the better-than-expected mortality experience). Likewise if no retirees died, then all retirees alive on the initial purchase would be included in the subsequent purchase and its pricing, but with projected mortality based on the mortality basis “locked-in” with the initial purchase and not projected to reflect the worse-than-expected actual mortality experience.

Item Six: structural relationship between initial purchase and subsequent years' purchase rates.

Consistent with historical group annuity precedent, with virtually no exceptions, the guarantees applicable to future deposits or purchases are always stronger in reverse proportion to the ratio of initial deposit to subsequent year's deposit. That is, if 75% of the total annuity liability is bought today, the spread-lock for future years' purchases can be more aggressive than if only 15% of the total liability is bought today.

Thus, a grid must be developed which reflects, to the satisfaction of both parties, the relationship between the relative size of the initial purchase purchases, i.e., is the initial purchase closer to 75% of 15% of the total?, and the correspondent risk premium to be subtracted from Rate X % for purposes of the subsequent purchases only (i.e., not the initial purchase):

| | | Illustrative |
|---|---|---|
| Initial Purchase | Subsequent 5 Years' | Subsequent 5 Years' risk |
| as a % of total | available purchase | premium to be subtracted |
| purchase available* | allocation per year | from Subsequent Years' Rates |
| 25% | 15% | 30 bp |
| 50% | 10% | 15 bp |
| 75% | 5% | 5 bp |

That is, there is a dynamic trade-off in the spread-lock structure between (a) minimizing the amount invested at today's low rates versus (b) maximizing the risk premium for the subsequent years' purchases. The exact details in the above grid should be determined between the parties, since they are the ones entering into the Spread Lock Annuity transaction. But, the idea of a dynamic tension between the relationship of initial deposit amount to subsequent deposit exposure is necessary for the actuarial and business soundness of the Spread Lock Annuity structure.

The Spreadsheet below elaborates on this conceptual trade-off, which is integral to the spread-lock innovation, within the historical context of group annuity guarantees. The specific risk charges are generally illustrative of what the parties would freely negotiate, but not necessarily specifically illustrative of this.

| | Amount of | | | | | |
|---|---|---|---|---|---|---|
| Initial Purchase | Subsequent | | | Rate | Rate | Rate |
| as a % of total, | annual | RC (Risk | | X % plus | X % plus | X % plus |
| and cost based | Purchases | Charge - | Subsequent | 50 bp | 100 bp | 150 bp |
| on Rate X % | (five) | illust.) | Year | (less RC) | (less RC) | (less RC) |
| 25% | 15% | 30 bp | 1 | $ | | $ |
| | 15% | 30 bp | 2 | $ | | |
| | 15% | 30 bp | 3 | $ | | |
| | 15% | 30 bp | 4 | $ | | |
| | 15% | 30 bp | 5 | $ | | |
| 50% | 10% | 15 bp | 1 | $ | | $ |
| | 10% | 15 bp | 2 | $ | | |
| | 10% | 15 bp | 3 | $ | | |
| | 10% | 15 bp | 4 | $ | | |
| | 10% | 15 bp | 5 | $ | | |
| 75% | 5% | 5 bp | 1 | $ | | $ |
| | 5% | 5 bp | 2 | $ | | |
| | 5% | 5 bp | 3 | $ | | |
| | 5% | 5 bp | 4 | $ | | |
| | 5% | 5 bp | 5 | $ | | |

That is, the specific details of risk charge and length of purchase period are illustrative. For example a given client and a given carrier may negotiate a seven, eight or even ten year purchase period, with greater or lower risk charges based on the specific details that the parties agree to. The overall structure, however, is critical to the Spread-Lock concept inasmuch as it provides the critical conceptual framework around which the dynamic tension between (a) initial purchase amount, (b) subsequent purchase amounts as a percentage of initial purchase amount, (c) subsequent purchase period and (d) risk charge, all revolve.

Similarly, the risk charge applicable to subsequent years' purchases (i.e. deposits) need not be uniform. For example, instead of a 10 basis point risk charge for each of the next five years' subsequent purchases, it could be 5 basis points for the first two years, 10 for the third year and 20 for the fourth and fifth year subsequent purchases.

Item Seven: Cessation of Subsequent Deposits

The Spread-Lock innovation conceptually requires subsequent deposits as its manner of mitigating current low interest rates, i.e., it provides for the future purchase of much of the total annuity liability at then-current rates but today's spreads and pricing basis, rather than for the total annuity liability to be purchased today at today's low rates.

As noted previously, the historical guarantee structure of the group annuity market (including Deposit Administration, IPG, and various GIC-type products) when subsequent deposits (i.e. subsequent “purchases” in annuity terminology) are included in the guarantee structure, involves (a) subsequent deposits/purchases made over a discrete period such as annually, (b) a limited deposit period of such subsequent deposits with these guarantees such as five, seven or ten years and (c) the ability of the Plan sponsor to cease such subsequent deposits.

Two available alternatives apply with respect to such subsequent deposits/purchases: an “options” model and a “futures” model.
1. The “options model” involves no penalty in the event the Plan Sponsor ceases subsequent deposits. The only cost to the plan sponsor is that when they cease one subsequent deposit, they lose the ability to make any other subsequent deposits, at least at those guarantees of spread and mortality. Already-existing purchases under the contract are un-affected.
2. Under the “futures model,” cessation of subsequent deposits/purchases works the same as under the “options model” except that there's a modest penalty for such cessation, expressed as a slight reduction (such as 0.5% or 1%) of the initial purchase, or an appropriately declining percentage of total purchases. This is a viable feature available only for “buy-in” annuities but not “buy-out” annuities, which are limited to the “options model” because all prior purchases will have constituted a distribution to the annuitant and with direct guarantees from the carrier to the annuitant, in contrast to the “buy-in” annuity form where the contract is not a distribution but an investment of the Trust, akin to a bond with mortality guarantees. It makes sense for clients and carriers to consider, particularly for initial-to-subsequent deposit ratios where the initial purchase is less than 50% of total purchases, because it provides for a less expensive subsequent deposit risk charge. (Too steep a subsequent deposit risk charge begins to undermine the entire rationale for the spread-lock).

Item Eight: how it works, i.e. how all these moving parts interact.
1. Plan sponsor (i.e. the purchaser of the Spread-Lock Group Annuity contract) decides what portion of the retiree liability to transfer, as described in Item One. (To illustrate in an example, assume 100% of the retiree liability).
2. Carrier quotes its single premium price and net rate, and how that premium would change under different interest rates, all other things being unchanged. Plan actuary verifies rate, and verifies carrier's quotes as to how that premium would change under various future rates, also as described in Item Two (a). As described in Item Two (b), the carrier refines its quote based on the percentage of benefits that the client wants to purchase now at today's rates, leaving the remainder available for future purchase at then-current rates but pre-established spreads, as to be described throughout this Item Eight. Carrier and Plan agree to a Pricing Rate from which rate increases or decreases will be applied, for purposes of future purchases under the contract. (To illustrate in this example, assume the carrier's quote is $500 million and that the Pricing Rate which correlates with this price, as agreed to by the carrier and Plan, is 3.25%).
3. As described in Item Three, the carrier also quotes how its price and liability values would unfold in three years, on the same liability base as in Item One, based on the carrier's expected mortality and specified future interest rates. This enables the Plan actuary to project the same values at the same future rates and projected three year time, based on the Plan's expectations of mortality. The Plan actuary identifies any substantive discrepancies between its values and the carrier's, and addresses those discrepancies with the carrier in order that the expectations of both parties for future price under varying interest rates based on expected mortality, are reasonably uniform. In this example, the carrier and Plan agree that a 100 pt increase in the Pricing Rate produces a lower price of 0.93% of $500 million, a 200 pt increase produces 0.87%, etc., in order that the Spread-Lock mechanism reflect the isolated impact of future rate change applied against the annuity population on the Effective Date. Likewise, the carrier and Plan agree on the future price under these same rate changes, but using projected mortality into future years during the purchase period. For example, if the entire purchase period is five years, then the pricing impact of expected mortality in (a) three years and (b) five years would be identified along with the pricing impact of the assumed future rate changes. In this example, the impact of projected mortality in three years on the initial $500 million value might be 80%, and in five years might be 60%, based on projected mortality in an annuity population of all retirees with a seven year assumed aggregate duration. Thus, the combined impact of both interest rate changes and projected mortality changes on the future price, are pre-established by virtue of the Spread-Lock mechanism. To illustrate, in this example the impact of a 100 pt. rate change plus projected mortality in three years is: $500 million times 0.93 times 0.8, or $372 million. Likewise, the impact of a 200 pt. rate increase in five years is: $500 million times 0.87 times 0.6, or $261 million.
4. As described in Item Four, the carrier and Plan agree to a definitional yardstick as to the measurement of interest rate changes to be applied against the portion of annuity liability to be purchased in subsequent years after the initial purchase. It can be a single rate yardstick like Moody's Aa or the 10 year Treasury yield, or a combination—whatever is mutually referred and agreeable between the parties. This is the measure of rate change to be applied to the underlying rate in the initial purchase as described in Item Two above. In this example, assume the same future rates as in Item Four are applicable and that the carrier and client agree to a definitional yardstick of future rates for purposes of this contract, of an average of Moody Aa and the 10 year Treasury, or 4.25% in three years and 6.75% in five years. Thus, for purposes of determining the appropriate future rate to use for annuity purchase in year three, rate X is 100 pts. higher than the initial purchase rate of 3.25% on the effective date, before application of the appropriate risk charge. Likewise the appropriate rate increase to use for the fifth year purchase (also before application of the risk charge) is 350 pts. higher than the 3.25% rate applicable to the initial purchase.
5. As per Item Five, the un-purchased benefits need to be updated if actual mortality experience is to be reflected in the subsequent purchases, as it should be to minimize disintermediation, unless the parties agree to using projected mortality instead. If expected mortality is consistent with actual mortality, then the pricing impact of actual mortality will be as predicted and described in #4 above (i.e. 80% remaining liability in three years and 60% in five years).
6. The above figures are expressed as percentages of the initial value—$500 million in this example—or as dollar amounts comparable to the $500 million, adjusted for (a) interest rate changes and (b) projected mortality. These are thus conceptually comparable values but for the isolated impact of two variables, interest and projected mortality. This is all to facilitate the apples-to-apples actuarial analysis which is at the heart of the Spread Lock operation. But what's actually being bought—today or in three or five years—is not the full $500 million, but smaller portions of it spread out over the purchase period. The ratio of initial purchase to subsequent purchase is a major variable too, since the concept of additional purchases to be made at future rates but a pre-determined spread off the initial purchase is the essence of the Spread-Lock notion. Item Six as described herein and as supplemented by the attached Excel Spreadsheet, outlines the Spread-Lock mechanism by which the ratio of initial purchase to subsequent purchase is captured, and the ricing impact of that ratio in terms of appropriate illustrative risk charge for those various ratios. In this example, assume that the ratio of initial purchase to subsequent purchases over a five year period is 50/50—that is, 50% (or $250 million) of each retiree's benefit is bought with the initial purchase, and the remaining 50% is available for purchase in 10% increments over the next 5 years, at then-prevailing interest rates. Thus, if interest rates (as defined in #4 above and Item Four preceding) increase 100 pts. in year 3, before application of the illustrative 15 bp risk charge, or 85 pts. afterward. Likewise in five years, if interest rates (again as described in #4 above and Item Four preceding) have risen 350 pts., then after the risk charge the net rate increase for the year five purchase is 335 pts. The net/net rate for the year 3 purchase is 4.1% (i.e. 3.25% plus the 100 pt. rate increase minus the 15 pt risk charge). Similarly the net/net rate for the year five purchase is 6.6% (i.e. 3.25% plus 350 pt. rate increase minus 15 pt. risk charge). The amount of initial purchase is not the full $500 million, but only half of that, and likewise each of the subsequent five year purchases is $50 million (before adjustment for projected or actual mortality and before application of any rate increase or risk charge). Using this same example but a different assumed ratio of initial purchase to subsequent purchase, instead of 50/50 the Plan and the carrier may agree to a ratio of 25% initial purchase and 75% remaining, to be apportioned in 5 annual increments of 15%. Thus, the initial purchase is for $125 million and each subsequent purchase is for $75 million, before application of future interest rates or projected or actual mortality. The subsequent year net/net purchase rates are the same as in the above example, except that the illustrative risk charge is 30 bp not 15 bp, in reflection of the different ratio of initial purchase amount to subsequent purchase amount.
7. Item 7 only becomes applicable in the event that the Plan chooses not to make a subsequent year purchase, in which case there's no impact on previous purchases in the buy-out annuity or the options model for buy-in annuity, other than that the Plan loses the right to make any additional purchases at the pre-established basis. Under the futures model—available only with buy-in annuity—cessation of future purchases triggers a small decrement in the total amount purchase, as pre-agreed between the carrier and Plan in exchange for a lower risk charge on subsequent purchases.

Non-recurring Revenue Potential: Assume total market potential is $1 trillion. Assume marketplace-reasonable pricing of 0.5 basis point per year of aggregate annuity liability duration per idea (assume 7 year aggregate duration all-retiree annuity population).

| % market penetration: | 10% | 20% | 40% |
|---|---|---|---|
| revenue: | $35M | $70M | $140M |

Basis for Potential Revenue Assessment: over 35 years specializing in the Group Annuity and Stable Value business working for both carriers and Plan sponsors, including over 22 as Director of Insurance Consulting at Towers Perrin, a major actuarial firm. Was one of the founding partners of Primco capital management (now Invesco), a major Stable Value manager.

The most practical likely use of the Spread-Lock Annuity innovation is in conjunction with a major actuarial firm like Hewitt EnnisKnupp or Mercer, or a major insurance company like Metroploitan or Prudential, for example. The numerous actuarial checks and interpolations required, particularly including calculations regarding the financial impact of interest rate changes and mortality expectations on thousands of participants' defined benefit pension benefits, makes such a synergistic linkage critical from a practical perspective.

The Spread Lock Annuity is a new innovation in the spectrum of Group Annuity products, for which the current market is as much as approximately $1 trillion. Currently very little annuity purchase activity is taking place, on either a “buy-in” or “buy-out” basis. Part of this is because most plans are underfunded nowadays, often as a result of today's low interest rates. The annuity rates available today are far lower than they have been historically, hence, annuities are more expensive than they have been historically for the same $1.00 of monthly benefit since the cost of the annuity is simply the commuted value—at a low current interest rate—of the expected future payments: the lower the rate, the more expensive the annuity.

Vital Computer Aspect. Annuity pricing and administration, as noted previously, is complex since it involves the amalgamation of many, many individuals' life expectancies and often their spouses' life expectancies too, and the interplay of these life expectancies with the participants' forms of annuity, prevailing interest rates and investments available at the time of purchase.

While this is true of all annuities, the added complication of the Spread Lock Annuity is that both the Plan sponsor and the carrier will need to do several price-reconciliation iterations in order to make sure that the “spread” that is locked in is correctly understood by both parties in terms of future price at various different interest rates. Numerous additional values pertaining to an annuitant population as of the effective date under various future interest rates, and various future years to show the combined impact of future rate changes and future mortality expectations, will need to be generated by both the carrier and the Plan.

Thus, where existing annuity pricing might require thousands of separate pricing calculations if there are thousands of annuitants, the Spread Lock will require multiples of that, depending on the number of price reconciliation iterations both parties (but primarily the Plan sponsor) will need, in order to know as definitively as possible the future cost in dollars of the remaining benefits to be purchased at the Locked-in Spread negotiated today, when spreads are so favorable, as part of the initial purchase.

Referring now to FIG. 1, Future Annuity Market Projection Illustrated without Spread Lock 010 is based on bond yields, not the annuity market, since the annuities will be bought at increasingly costly spreads off Aa bonds as demand increases and “top annuity rate” capacity diminishes; the actual cost of the annuity purchase will increasingly exceed the regulatory funding levels.

The Future Annuity Market Projection Illustrated without Spread Lock 010 is illustrated by showing the Purchase of a Fraction of Monthly Benefits 110. Purchase Volume 100 is illustrated on the y-axis. Future Spreads off Aa bonds as Demand Increases 300 is illustrated on the x-axis. Future Market Demand 200 is illustrated by increments of Funding 210 and increments of Interest Rates 220. Funding 210 is based on bond yields, not the annuity market (Since the annuities will be bought at increasingly costly spread off Aa bonds as demand increases and “top annuity rate” capacity diminishes, the actual cost of the annuity purchase will increasingly exceed the regulatory funding levels. Future excess annuity cost incurred due to spread changes as annuity demand increases 310 is illustrated to show the need for spread lock annuities.

Referring now to FIG. 2, Future Annuity Market Projection Illustrated With Spread Lock 020 is illustrated by showing the addition of Spread Lock 400, (the current great spreads locked-in for tomorrow's higher rates) added to the Purchase of a Fraction of Monthly Benefits 110. The Future excess annuity cost avoided due to spread lock 500 is illustrated showing the result of Spread Lock 400. Funding 230 is illustrated and would be the “technical” funding percentage as per regulation based on bond yields, not the annuity market (since the annuities will be bought at increasingly costly spreads off Aa bonds as demand increases and “top annuity rate” capacity diminishes, the actual cost of the annuity purchase will increasingly exceed the regulatory funding levels.

The Spread Lock Annuity is a new innovation in the spectrum of Group Annuity products, for which the current market is as much as approximately $1 trillion. Currently very little annuity purchase activity is taking place, on either a “buy-in” or “buy-out” basis. Part of this is because most plans are underfunded nowadays, often as a result of today's low interest rates. The annuity rates available today are far lower than they have been historically, hence, annuities are more expensive than they have been historically for the same $1.00 of monthly benefit since the cost of the annuity is simply the commuted value, at a low current interest rate, of the expected future payments: the lower the rate, the more expensive the annuity.

Because annuities comprise a form of life insurance whereby the payments are guaranteed by the carrier for the life of the annuitant, the group annuity policies (which may cover dozens, hundreds or even thousands of annuitants) are not considered investments and are not subject to SEC regulation. Rather, they are considered to be insurance products and as such, are regulated by the state insurance commissioners.

All annuities, including the Spread Lock annuity, require extensive computer calculations and process to price and administer, since the life expectancies of each annuitant, and often the annuitants' beneficiaries too, need to be reflected in the calculations.

The essence of the Spread Lock annuity is that it only involves purchasing a portion of participants' benefits. Instead of buying 100% of the retirees' benefits, for example, the Spread Lock annuity only purchases a portion such as 10%, 25%, 50%, etc., whatever is mutually agreed by the carrier and Plan sponsor.

What's unique about the Spread Lock annuity is that it also involves, as part of the purchase of a portion of benefit, an option on the part of the Plan sponsor to purchase the rest of the participants' benefits on a pre-agreed basis linked to spreads of Aa bonds, not future minimum rate guarantees, as has historically been the case.

As such, the Spread Lock Annuity does what no other currently existent annuity does: it minimizes the Plan sponsor's purchase at today's low and unattractive rates while at the same time “locking in” for the Plan sponsor guaranteed access to today's great spreads, at tomorrow's higher rates. As such it combines (a) the carriers' need to generate some actual annuity purchase business today (i.e. despite today's low rates) with the Plan sponsor's desire to (b) establish a glide-path for eventual transfer of their pension plan liabilities, at least for retirees, to the “safest available” party but at a reasonable cost. The Plan Sponsor concern is that as rates rise and annuity demand picks up, spreads will greatly worsen and capacity will diminish as the annuity market shifts from today's buyer's market to tomorrow's seller's market.

The carrier does potentially sacrifice some potential future opportunity cost, but many will be comfortable exchanging a future potential opportunity cost for a new annuity business today, when they are desperate for it, and which will not represent a material future risk since it's just the spread, not the future rate, that's licked in.

Important Computer Aspect. Annuity pricing and administration, as noted previously, is complex since it involves the amalgamation of many, many people's life expectancies and often their spouse's life expectancies too, and the interplay of these life expectancies with the participants' forms of annuity, prevailing interest rates and investments available at the time of purchase.

This is true of all annuities. The added complication of the Spread Lock Annuity is that both the Plan sponsor and the carrier will need to do several price-reconciliation iterations in order to make sure that the “spread” that's locked in is correctly understood by both parties in terms of future price at various different interest rates. Thus, where existing annuity pricing might require thousands of separate pricing calculations if there are thousands of annuitants, the Spread Lock will require multiples of that depending on the number of price reconciliation iterations both parties (but primarily the Plan sponsor) will need, in order to know as definitively as possible the future cost in dollars of the remaining benefits to be purchased at the Locked-in Spread negotiated today, when spreads are so favorable, as part of the initial purchase.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered.

What is claimed is:

1. A system for creating a spread-lock group annuity contract, the system comprising the steps of
a. deciding by a purchaser of what portion of the retiree liability to transfer;
b. providing a quote by a carrier of a single premium price, a net rate and premium changes under different interest rates;
c. verifying by a plan actuary of the single premium price, the net rate and the premium changes;
d. refining the quote by the carrier based on a percentage of benefits desired by the purchaser to purchase as current rates;
e. leaving a remainder available for future purchase at current rates but pre-established spreads;
f. agreeing by the purchaser and the carrier to a pricing rate from which rate increases or decreases will apply for future purchases;
g. quoting by the carrier how price and liability values unfold over a contract duration, based on expected mortality and specified future interest rates;
h. agreeing by the carrier and the purchaser to a definitional yardstick as to a measurement of interest rate changes to be applied against a portion of annuity liability to be purchased after an initial purchase; and
i. updating, using a computer, un-purchased benefits in order to reflect actual mortality experience in subsequent purchases.
